(19) United States
(12) Patent Application Publication
(10) Pub. No.: US 2026/0327427 A1
(43) Pub. Date: Oct. 22, 2026

(54) ASPHALT COMPOSITION

(71) Applicant: KAO CORPORATION, Tokyo (JP)

(72) Inventors: Machiko IE, High Point, NC (US); Mohand MELBOUCI, High Point, NC (US); Yusuke AKINO, Tokyo (JP); Eiji SHIRAI, Tokyo (JP)

(73) Assignee: KAO CORPORATION, Tokyo (JP)

(21) Appl. No.: 18/880,865

(22) PCT Filed: Aug. 3, 2022
(86) PCT No.: PCT/US2022/039237

§ 371 Date: Jan. 3, 2025

(51) Int. Cl. C08L 95/00; C04B 26/26

(52) U.S. Cl. CPC C08L 95/00; C04B 26/26

(57) ABSTRACT

The present invention relates to an asphalt composition containing asphalt and a polyester resin, wherein the polyester resin contains a constitutional unit derived from an alcohol component and a constitutional unit derived from a carboxylic acid component, the alcohol component contains ≥30% by mol of an alkylene oxide adduct of bisphenol A, the polyester resin has a glass transition point of ≥−70° C. and ≤10° C., and the content of the polyester resin is ≥0.5 part by mass and ≤15 parts by mass per 100 parts by mass of the asphalt.

### FIELD OF THE INVENTION

The present invention relates to an asphalt composition.

### BACKGROUND OF THE INVENTION

An asphalt mixture has been designed with aggregates for surface paving of automotive roads, parking spaces, freight yards, sidewalks, and the like to provide a paved surface with a desired durability.

PTL 1 (WO 2018/003151) describes an asphalt composition for road pavement containing asphalt, a particular polyester resin, and aggregates, to provide excellent deformation resistance and water immersion strength

### SUMMARY OF THE INVENTION

The present invention relates to an asphalt composition containing asphalt and a polyester resin, wherein:
the polyester resin contains a constitutional unit derived from an alcohol component and a constitutional unit derived from a carboxylic acid component, the alcohol component containing 30% by mol or more of an alkylene oxide adduct of bisphenol A,
the polyester resin has a glass transition temperature comprised between −70° C. and 10° C.,
the asphalt composition has polyester resin content between 0.5 and 15 parts by mass per 100 parts of the mass of asphalt.

### DETAILED DESCRIPTION OF THE INVENTION

The asphalt pavement suffers from cracks caused by the stress due to the weight and vibrations of vehicles traveling repeated for a prolonged period of time. Those cracks largely impair the safety of the asphalt pavement and the appearance of the pavement surfaces.

The low amount of asphalt binder is claimed as one of the factors causing the cracks in the asphalt pavement. The asphalt pavement retains the strength thereof by the aggregates having a certain particle size distribution that are bound with the asphalt. Aggregates that are different in type and size from each other and different in efficiency due their interaction with the asphalt binder (which may also be referred to as wettability). After adjusting the desired binder amount, the portion of the aggregates that are not covered with the asphalt binder, for example, small particle size aggregates, tend to be a trigger point for cracking. Increasing the amount of binder than required would improve the aggregates coverage, but the excess of the binder would affect the stability and durability of the pavement.

In the technique of PTL 1, the aggregate is covered with the asphalt binder to enhance the strength and interaction at the interface between the aggregate and the asphalt. However, the aggregates that are not sufficiently covered asphalt binder, the extent of the interaction at the interface may be insufficient.

The present invention relates to an asphalt composition that can improve crack resistance of paved surfaces.

The present invention relates to the following item [1].

[1] An asphalt composition containing asphalt and a polyester resin, wherein:
the polyester resin contains a constitutional unit derived from an alcohol component and a constitutional unit derived from a carboxylic acid component, the alcohol component containing 30% by mol or more of an alkylene oxide adduct of bisphenol A,
the polyester resin has a glass transition temperature comprised between −70° C. and 10° C.,
the asphalt composition has a polyester resin content comprised between of 0.5 and 15 parts by mass per 100 parts by mass of asphalt.

### Asphalt Composition

The asphalt composition of the present invention contains asphalt and a polyester resin, wherein, the polyester resin contains a constitutional unit derived from an alcohol component and a constitutional unit derived from a carboxylic acid component, the alcohol component contains 30% by mol or more of an alkylene oxide adduct of bisphenol A, the polyester resin has a glass transition temperature between −70° C. and 10° C., and the content of the polyester resin is comprised between 0.5 and 15 parts by mass per 100 parts by mass of asphalt.

The present inventors have found that significant benefits can be achieved by an asphalt composition that contains a polyester resin having a particular structure and particular thermal characteristics in a particular amount.

The mechanism of action of the present invention may not be clearly understood but can be explained as following.

It is believed that the low molecular weight component of asphalt forms a composite with the polyester resin, and that the composite efficiently covers the aggregates.

Due to the low glass transition temperature (Tg) of the polyester resin used in the present invention, which is in a liquid form, can undergo molecular motion for a prolonged period in the cooling process after pavement. As a result, because of its liquid form, the contact area thereof with the asphalt is increased to enhance the formation rate and the formation amount of the composite of the low molecular weight component of the asphalt and the polyester resin, resulting in improved cracking resistance of the asphalt mixture.

The terminology used in the description herein is defined below.

In the polyester resin, the “constitutional unit derived from an alcohol component” means a structure obtained by removing the hydrogen atom from the hydroxy group of the alcohol component, and the “constitutional unit derived from a carboxylic acid component” means a structure obtained by removing the hydroxy group from the carboxy group of the carboxylic acid component.

The “carboxylic acid component” is a concept that encompasses not only the carboxylic acid itself, but also an anhydride and an alkyl ester of the carboxylic acid (for example, the alkyl group having between 1 and 3 carbon atoms) forming the carboxylic acid through decomposition during the reaction. In the case where the carboxylic acid component is an alkyl ester of the carboxylic acid, the number of carbon atoms of the alkyl group as the alcohol residue of the ester is not counted in the number of carbon atoms of the carboxylic acid.

Bisphenol A is 2,2-bis(4-hydroxyphenyl)propane.

### Asphalt

The asphalt composition of the present invention contains asphalt.

The asphalt used may be various types of asphalt. Examples thereof include straight asphalt binder, a non-polymer modified bitumen, and modified asphalt.

The straight asphalt means a residual bituminous substance obtained by subjecting a crude oil to an atmospheric distillation equipment, a reduced-pressure distillation equipment, or the like.

Examples of the modified asphalt include blown asphalt; and a polymer-modified asphalt that is modified with a polymeric material, such as a thermoplastic elastomer or a thermoplastic resin (which may be hereinafter referred to as a “polymer-modified asphalt”). The blown asphalt means asphalt obtained in such a manner that a mixture of straight asphalt and a heavy oil is heated and then oxidized by blowing air therein.

The asphalt is preferably selected from straight asphalt and polymer-modified asphalt, wherein, the polymer-modified asphalt is preferred from the standpoint of the durability of the asphalt pavement, and straight asphalt is preferred from the standpoint of the general versatility.

### Thermoplastic Elastomer

Examples of the thermoplastic elastomer in the polymer-modified asphalt include at least one polymer selected from a styrene-butadiene block copolymer, a styrene-butadiene-styrene block copolymer, a styrene-butadiene random copolymer, a styrene-isoprene block copolymer, a styrene-isoprene-styrene block copolymer, a styrene-isoprene random copolymer, an ethylene-vinyl acetate copolymer, an ethylene-acrylate ester copolymer, a styrene-ethylene-butylene-styrene copolymer, a styrene-ethylene-propylene-styrene copolymer, a polyurethane based thermoplastic elastomer, a polyolefin based thermoplastic elastomer, an isobutylene-isoprene copolymer, polyisoprene, polychloroprene, synthetic rubber other than these materials, and natural rubber.

Among these, the thermoplastic elastomer is preferably at least one selected from styrene-butadiene block copolymer, styrene-butadiene-styrene block copolymer, styrene-butadiene random copolymer, styrene-isoprene block copolymer styrene-isoprene-styrene block copolymer, styrene-isoprene random copolymer, and an ethylene-acrylate ester copolymer, more preferably selected from styrene-butadiene block copolymer, styrene-butadiene-styrene block copolymer, styrene-butadiene random copolymer, styrene-isoprene block copolymer, styrene-isoprene-styrene block copolymer, and styrene-isoprene random copolymer, and further preferably at least one selected from styrene-butadiene random copolymer and styrene-butadiene-styrene block copolymer, from the standpoint of the durability of the asphalt pavement.

The content of the thermoplastic elastomer in the polymer-modified asphalt is preferably ≥0.1% by mass, more preferably ≥0.5% by mass, and further preferably ≥1% by mass, and is preferably ≤30% by mass, more preferably ≤15% by mass, and further preferably ≤5% by mass, from the standpoint of the durability of the asphalt pavement.

The total content of the straight asphalt and the polymer-modified asphalt in the asphalt composition is preferably ≥60% by mass, more preferably ≥65% by mass, and further preferably ≥70% by mass, from the standpoint of exerting the asphalt capability, and is preferably ≤99.5% by mass, more preferably ≤99% by mass, and further preferably ≤98% by mass, from the standpoint of the storage stability.

### Polyester Resin

The asphalt composition of the present invention contains a polyester resin.

The polyester resin contains a constitutional unit derived from an alcohol component and a constitutional unit derived from a carboxylic acid component, and the alcohol component contains ≥30% by mol of an alkylene oxide adduct of bisphenol A.

The polyester resin has a glass transition temperature≥−70° C. and ≤10° C.

The alcohol component, the carboxylic acid component, the properties of the polyester resin, and the like are described below.

### Alcohol Component

The alcohol component contains ≥30% by mol of an alkylene oxide adduct of bisphenol A from the standpoint of the crack resistance.

The alkylene oxide adduct of bisphenol A is a diol compound having bisphenol A and one or plural alkylene oxide added thereto, and specific examples thereof include an alkylene oxide adduct of bisphenol A represented by the following formula (I).

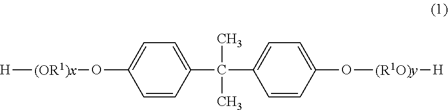

In the formula (I), OR¹ and R¹O each independently represent an oxyalkylene group having ≥1 and ≤4 carbon atoms.

x and y each are addition molar numbers of the alkylene oxide, and each independently represent a positive number of ≥0.

In the alkylene oxide adduct of bisphenol A, examples of the one or plural alkylene oxide added thereto include an alkylene oxide having ≥1 and ≤4 carbon atoms, in which ethylene oxide and propylene oxide are preferred.

Accordingly, the alkylene oxide adduct of bisphenol A may have one or plural oxyalkylene group having ≥1 and ≤4 carbon atoms, and preferably has an oxyethylene group or an oxypropylene group.

The oxyalkylene group is represented by OR¹ and R¹O in the formula (I).

In the alkylene oxide adduct of bisphenol A, the average addition molar number of the alkylene oxide is preferably ≥5 and more preferably ≥6, and is preferably ≤20, more preferably ≤18, and further preferably ≤17, from the standpoint of cracking resistance.

The average addition molar number of the alkylene oxide is represented by the average value of the sum of x and y in the formula (I).

Examples of the alkylene oxide adduct of bisphenol A represented by the formula (I) include a propylene oxide adduct of bisphenol A and an ethylene oxide adduct of bisphenol A. Among these, a propylene oxide adduct of bisphenol A is preferred from the standpoint of cracking resistance.

The average addition molar number of the propylene oxide is preferably ≥5 and more preferably ≥6 and is preferably ≤20, more preferably ≤18, and further preferably ≤17, from the standpoint of cracking resistance.

The alkylene oxide adduct of bisphenol A may be used alone or as a combination of two or more kinds thereof.

The content of the alkylene oxide adduct of bisphenol A in the alcohol component may be ≥30% by mol and is preferably ≥50% by mol, more preferably ≥70% by mol, further preferably ≥80% by mol, and still further preferably ≥90% by mol, from the same standpoint as above, and is ≤100% by mol.

In one of preferred embodiments of the present invention, the alcohol component is formed only of an alkylene oxide adduct of bisphenol A.

The alcohol component may contain an additional alcohol component other than the alkylene oxide adduct of bisphenol A. Examples of the additional alcohol component include an aliphatic diol, an alicyclic diol, an aromatic diol other than the alkylene oxide adduct of bisphenol A, and a trihydric or higher polyhydric alcohol. These alcohol components may be used alone or as a combination of two or more kinds thereof.

The aliphatic diol is preferably a linear or branched aliphatic diol having a main chain having ≥2 and ≤12 carbon atoms, and more preferably a linear or branched aliphatic diol having a main chain having ≥2 and ≤8 carbon atoms.

The aliphatic diol is preferably a saturated aliphatic diol.

Specific examples of the aliphatic diol include ethylene glycol, 1,2-propanediol, 1,3-propanediol, 1,3-butanediol, 1,4-butanediol, 1,4-butenediol, 1,5-pentanediol, 1,6-hexanediol, neopentyl glycol, 1,10-decanediol, and 1,12-dodecanediol.

Examples of the alicyclic diol include hydrogenated bisphenol A (2,2-bis(4-hydroxycyclohexyl)propane), an alkylene oxide adduct of hydrogenated bisphenol A, cyclohexanediol, and cyclohexanedimethanol.

Examples of the aromatic diol other than the alkylene oxide adduct of bisphenol A include bisphenol A [2,2-bis(4-hydroxyphenyl)propane].

The trihydric or higher polyhydric alcohol is preferably a trihydric alcohol. Examples of the trihydric or higher polyhydric alcohol include glycerin, pentaerythritol, trimethylolpropane, and sorbitol.

The alcohol component may further contain a monohydric aliphatic alcohol from the standpoint of the regulation of the properties. Examples of the monohydric aliphatic alcohol include lauryl alcohol, myristyl alcohol, palmityl alcohol, and stearyl alcohol. The monohydric aliphatic alcohol may be used alone or in a combination with two or more kinds thereof.

### Carboxylic Acid Component

Examples of the carboxylic acid component include an aliphatic dicarboxylic acid, an aromatic dicarboxylic acid, and a tribasic to hexabasic polybasic carboxylic acid. The carboxylic acid component may be used alone or in a combination with two or more kinds thereof.

Examples of the aliphatic dicarboxylic acid include an aliphatic dicarboxylic acid having a main chain having preferably ≥4, and preferably ≤10, more preferably ≤8, and further preferably ≤6 carbon atoms, such as fumaric acid, maleic acid, oxalic acid, malonic acid, citraconic acid, itaconic acid, glutaconic acid, succinic acid, adipic acid, suberic acid, azelaic acid, sebacic acid, dodecanedioic acid, succinic acid substituted by an alkyl group having ≥1 and ≤20 carbon atoms or an alkenyl group having ≥2 and ≤20 carbon atoms, anhydrides thereof, and alkyl esters thereof (for example, the alkyl group has ≥1 and ≤3 carbon atoms). Examples of the substituted succinic acid include dodecylsuccinic acid, dodecenylsuccinic acid, and octenylsuccinic acid.

The aliphatic dicarboxylic acid is preferably the alkenylsuccinic acid described above, sebacic acid, adipic acid, or anhydrides thereof, more preferably the alkenylsuccinic acid described above, sebacic acid, or anhydrides thereof, and further preferably the alkenylsuccinic acid described above or an anhydride thereof, from the standpoint of the crack resistance.

Examples of the aromatic dicarboxylic acid include phthalic acid, terephthalic acid, isophthalic acid, naphthalenedicarboxylic acid, anhydrides thereof, and alkyl esters thereof (for example, the alkyl group has ≥1 and ≤3 carbon atoms). In the aromatic dicarboxylic acid, isophthalic acid and terephthalic acid are preferred, and terephthalic acid is more preferred, from the standpoint of the durability of the asphalt pavement.

The tribasic to hexabasic polybasic carboxylic acid is preferably a tribasic carboxylic acid. Examples of the tribasic to hexabasic polybasic carboxylic acid include trimellitic acid, 2,5,7-naphthalenetricarboxylic acid, pyromellitic acid, and anhydrides thereof.

The carboxylic acid component may further contain a monobasic aliphatic carboxylic acid from the standpoint of the regulation of the properties. Examples of the monobasic aliphatic carboxylic acid include a monobasic aliphatic carboxylic acid having ≥12 and ≤20 carbon atoms, such as lauric acid, myristic acid, palmitic acid, and stearic acid, and alkyl (having ≥1 and ≤3 carbon atoms) esters of these acids. The monobasic aliphatic carboxylic acid may be used alone or as a combination of two or more kinds thereof.

In one of preferred embodiments of the present invention, the carboxylic acid component contains succinic acid substituted by an alkenyl group having ≥2 and ≤20 carbon atoms (i.e., an alkenylsuccinic acid).

In the case where the carboxylic acid component contains an alkenylsuccinic acid, the content of the alkenylsuccinic acid in the carboxylic acid component is preferably ≥50% by mol, more preferably ≥70% by mol, further preferably ≥80% by mol, and still further preferably ≥90% by mol, and is ≤100% by mol, from the same standpoint as above.

In one of preferred embodiments of the present invention, the carboxylic acid component is formed only of succinic acid substituted by an alkenyl group having ≥2 and ≤20 carbon atoms.

Molar Ratio of Constitutional Unit Derived from Carboxylic Acid Component with Respect to Constitutional Unit Derived from Alcohol Component

The molar ratio of the constitutional unit derived from the carboxylic acid component with respect to the constitutional unit derived from the alcohol component (carboxylic acid component/alcohol component) is preferably ≥0.7, more preferably ≥0.8, and further preferably ≥0.85, and is preferably ≤1.3, more preferably ≤1.2, and further preferably ≤1.0.

### Ester Group Concentration of Polyester Resin

The ester group concentration of the polyester resin is preferably 0.9 mmol/g, more preferably ≥1.0 mmol/g, and further preferably ≥1.1 mmol/g, and is preferably ≤3.0 mmol/g, more preferably ≤2.8 mmol/g, and further preferably ≤2.5 mmol/g, from the standpoint of cracking resistance.

Specifically, it is considered that the ester group concentration of the polyester resin within the range lowers the self-cohesive force of the polyester resin, and as a result, the efficiency in covering the aggregate with the asphalt binder can be further increased to enhance the crack resistance.

The ester group concentration of the polyester resin can be obtained according to the method described in the examples later.

### Properties of Polyester Resin

The glass transition point (Tg) of the polyester resin is ≥−70° C. and ≤10° C., is preferably ≥−60° C., more preferably ≥−50° C., further preferably ≥−48° C., and still further preferably ≥−45° C., and is preferably ≤5° C., more preferably ≤3° C., further preferably ≤0° C., and still further preferably ≤−5° C., from the standpoint of cracking resistance.

The acid value of the polyester resin is preferably ≥2 mgKOH/g, more preferably ≥3 mgKOH/g, and further preferably ≥4 mgKOH/g, and is preferably ≤20 mgKOH/g, more preferably ≤15 mgKOH/g, and further preferably ≤13 mgKOH/g, from the same standpoint.

The hydroxy value of the polyester resin is preferably 5 mgKOH/g or more, more preferably ≥10 mgKOH/g, and further preferably ≥13 mgKOH/g, and is preferably ≤40 mgKOH/g, more preferably ≤30 mgKOH/g, and further preferably ≤25 mgKOH/g, from the same standpoint.

The melt viscosity at 90° C. of the polyester resin is preferably ≥300 mPa·s, more preferably ≥350 mPa·s, and further preferably ≥400 mPa·s and is preferably ≤30,000 mPa·s, more preferably ≤10,000 mPa·s, and further preferably 3≤,000 mPa·s, from the same standpoint.

The number average molecular weight (Mn) of the polyester resin is preferably ≥2,500, more preferably ≥3,000, and further preferably ≥3,500, and is preferably ≤10,000, more preferably ≤7,000, and further preferably ≤5,000, from the same standpoint.

The weight average molecular weight (Mw) of the polyester resin is preferably ≥7,000, more preferably ≥8,000, and further preferably ≥10,000, and is preferably ≤30,000, more preferably ≤20,000, and further preferably ≤16,000, from the same standpoint.

The glass transition point, the acid value, the hydroxy value, the melt viscosity at 90° C., the number average molecular weight, and the weight average molecular weight of the polyester resin can be measured according to the method described in the examples later. The glass transition point, the acid value, the hydroxy value, the melt viscosity at 90° C., the number average molecular weight, and the weight average molecular weight parameters can be adjusted by the raw material monomer composition, the molecular weight thereof, the amount of the catalyst, and the reaction conditions.

The polyester resin may be a polyester resin that is modified in such an extent that substantially does not impair the characteristics thereof. Specific examples of the modified polyester resin include polyester resins that each are formed into a graft polymer or a block polymer with such a compound as phenol, urethane, or epoxy according to the methods described in JP 11-133668 A, JP 10-239903 A, JP 8-20636 A, and the like. Preferred examples of the modified polyester resin include a urethane-modified polyester resin obtained by extending a polyester resin with a polyisocyanate compound.

### Production Method of Polyester Resin

The production method of the polyester resin constituting the asphalt composition of the present invention is not particularly limited, and for example, the polyester resin can be produced through polycondensation of the alcohol component and the carboxylic acid component described above.

The blending amounts of the alcohol component and the carboxylic acid component is such blending amounts that make the molar ratio of the constitutional unit derived from the carboxylic acid component with respect to the constitutional unit derived from the alcohol component (carboxylic acid component/alcohol component) within the aforementioned numerical range.

The temperature in the polycondensation reaction is preferably ≥160° C., more preferably ≥180° C., and further preferably ≥190° C., and is preferably ≤260° C., more preferably ≤250° C., and further preferably ≤240° C., from the standpoint of reactivity.

In the polycondensation reaction, an esterification catalyst may be used from the standpoint of the reaction speed. Examples of the esterification catalyst include a tin(II) compound having no Sn—C bond, such as tin(II) di(2-ethylhexanoate). The amount of the esterification catalyst used is preferably ≥0.01 part by mass, more preferably ≥0.1 part by mass, and further preferably ≥0.2 part by mass, and is preferably ≤1.5 parts by mass, more preferably ≤1.0 part by mass, and further preferably ≤0.6 part by mass per 100 parts by mass of the total amount of the alcohol component and the carboxylic acid component, from the standpoint of reaction speed.

In the polycondensation reaction, a promotor may be used in addition to the esterification catalyst. Examples of the promotor include a pyrogallol compound, such as gallic acid. The amount of the promotor used is preferably ≥0.001 part by mass, more preferably ≥0.005 part by mass, and further preferably ≥0.01 part by mass, and is preferably ≤0.15 part by mass, more preferably ≤0.10 part by mass, and further preferably ≤0.05 part by mass per 100 parts by mass of the total amount of the alcohol component and the carboxylic acid component.

### Content of Polyester Resin

The content of the polyester resin in the asphalt composition is 0.5 part by mass or more and 15 parts by mass or less, is preferably ≥1 part by mass, more preferably ≥1.5 parts by mass, and further preferably ≥2 parts by mass, and is preferably ≤12 parts by mass, more preferably ≤10 parts by mass, and further preferably ≤5 parts by mass per 100 parts by mass of the asphalt, from the standpoint of storage stability.

### Production Method of Asphalt Composition

The asphalt composition of the present invention may be produced by mixing the asphalt and the polyester resin. Specifically, the asphalt composition may be obtained in such a manner that the asphalt is melted under heating, to which the polyester resin is added, and the components are mixed with a standard benchtop mixer until the polyester resin is uniformly dispersed in the asphalt.

Examples of the standard benchtop mixer include a homogenizer, a dissolver, a paddle mixer, a ribbon mixer, a screw mixer, a planetary mixer, a vacuum counterflow mixer, a roll mill, and a twin-screw extruder.

The mixing temperature of the asphalt and the polyester resin is preferably ≥140° C., and more preferably ≥150° C., and is preferably ≤190° C., more preferably ≤180° C., and further preferably ≤170° C., from the standpoint of dispersing the polyester resin uniformly in the asphalt.

The mixing time of the asphalt and the polyester resin is preferably ≥1 minute, more preferably ≥10 minutes, and further preferably ≥30 minutes, from the standpoint of dispersing the polyester resin uniformly in the asphalt, and is preferably ≤48 hours, more preferably ≤30 hours, and further preferably ≤24 hours, from the standpoint of preventing the thermal degradation of the asphalt composition.

The asphalt composition of the present invention contains a binder that is mixed with aggregates to make a hot mix asphalt composition. Accordingly, the asphalt composition of the present invention is suitable for surface pavement, and particularly suitable for road pavement.

### Asphalt Mixture

An asphalt mixture as a preferred use example of the asphalt composition is described below.

The asphalt mixture contains at least an aggregate, asphalt binder, and polyester resin.

### Aggregate

The aggregate used may be selected from crushed stone, cobbled stone, ballast, sand, recycled aggregates, and ceramics. The aggregates used may be any of coarse aggregates having a particle diameter of ≥2.36 mm and a fine aggregate having a particle diameter of ≤2.36 mm. A combination of coarse aggregates and fine aggregates is preferred.

The content of the aggregate in the asphalt mixture is preferably ≥85% by mass, more preferably ≥90% by mass, and further preferably ≥92% by mass, and is preferably ≤98% by mass, more preferably ≤97% by mass, and further preferably ≤96% by mass based on 100% by mass of the asphalt mixture, from the standpoint of the durability of the asphalt pavement.

### Additives

Various additives that have been commonly used in asphalt mixtures, such as film forming agents, thickening stabilizers, and emulsifiers, may be added, as needed, to the asphalt mixture, in addition to the aggregates, asphalt, and polyester resin described above.

The total content of the additives is preferably ≤50% by mass, more preferably ≤25% by mass, and further preferably ≤5% by mass based on 100% by mass of the asphalt mixture.

### Production Method of Asphalt Mixture

The production method of the asphalt mixture is not particularly limited, and the asphalt mixture may be produced by any production method. In general, the asphalt mixture may be produced according to a production method of an asphalt mixture containing aggregates and asphalt. Specific examples thereof include a method of adding the asphalt composition to the heated aggregate, and mixing the components.

The temperature of the heated aggregate is preferably ≥130° C., more preferably ≥150° C., and further preferably ≥160° C., from the standpoint of homogeneous mixing of the components, and is preferably ≤230° C., more preferably ≤200° C., and further preferably ≤170° C., from the standpoint of preventing the thermal degradation of the asphalt.

The mixing temperature of the aggregate and the asphalt composition is preferably ≥130° C., more preferably ≥150° C., and further preferably ≥160° C., from the standpoint of homogeneous mixing of the components, and is preferably ≤230° C., more preferably ≤200° C., and further preferably ≤170° C., from the standpoint of preventing the thermal degradation of the asphalt.

The mixing time of the aggregate and the asphalt composition is not particularly limited, is preferably ≥30 seconds, more preferably ≥1 minute, and further preferably ≥2 minutes, and is preferably ≤2 hours, more preferably ≤1 hour, and further preferably ≤30 minutes.

The production method of the asphalt mixture preferably includes, after mixing the aggregate and the asphalt composition, a curing step consisting of retaining the resulting asphalt mixture at the mixing temperature or a temperature higher than the mixing temperature, from the standpoint of the durability of the asphalt pavement.

During the curing step of the asphalt mixture, the mixture may be further mixed.

The retaining time is preferably ≥0.5 hour, more preferably ≥1 hour, and further preferably ≥1.5 hours, and the upper limit of the time is not particularly limited, and may be, for example, approximately 48 hours.

### Road Pavement Method

The asphalt mixture is suitable for road pavement, and as described above, an asphalt mixture containing the asphalt composition having an aggregate added thereto is used for road pavement.

The road pavement method includes a step of laying down the asphalt mixture on the road to form an asphalt pavement layer. Specifically, the road pavement method may include a step of mixing the asphalt composition and the heated aggregate to provide the asphalt mixture (step 1), and a step of laying down the asphalt mixture obtained in the step 1 on the road to form an asphalt pavement layer (step 2). The asphalt pavement layer is preferably a base layer or a surface layer.

In relation to the embodiments described above, the present invention further relates to the following asphalt compositions.

<1> An asphalt composition containing asphalt and a polyester resin, wherein
the polyester resin contains a constitutional unit derived from an alcohol component and a constitutional unit derived from a carboxylic acid component. The alcohol component contains ≥30% by mol of an alkylene oxide adduct of bisphenol A.

<2> An asphalt composition containing asphalt and a polyester resin, wherein
the polyester resin contains a constitutional unit derived from an alcohol component and a constitutional unit derived from a carboxylic acid component. The alcohol component contains ≥50% by mol of an alkylene oxide adduct of bisphenol A.

<3> An asphalt composition containing asphalt and a polyester resin, wherein
the polyester resin contains a constitutional unit derived from an alcohol component and a constitutional unit derived from a carboxylic acid component. The alcohol component contains ≥70% by mol of an alkylene oxide adduct of bisphenol A.

<4> The asphalt composition according to any one of the items <1> to <3>, wherein the alkylene oxide adduct of bisphenol A has an average addition molar number of the alkylene oxide of ≥5 and ≤20.

<5> The asphalt composition according to any one of the items <1> to <4>, wherein the alkylene oxide of the alkylene oxide adduct of bisphenol A is propylene oxide.

<6> The asphalt composition according to any one of the items <1> to <5>, wherein the polyester resin has a glass transition point of ≥−70° C. and ≤10° C.

<7> The asphalt composition according to any one of the items <1> to <5>, wherein the polyester resin has a glass transition point of ≥−70° C. and ≤3° C.

<8> The asphalt composition according to any one of the items <1> to <5>, wherein the polyester resin has a glass transition point of ≥−70° C. and ≤0° C.

<9> The asphalt composition according to any one of the items <1> to <5>, wherein the polyester resin has a glass transition point of ≥−70° C. and ≤−5° C.

<10> The asphalt composition according to any one of the items <1> to <9>, wherein the polyester resin has a melt viscosity at 90° C. of ≥300 cP and ≤30,000 cP.

<11> The asphalt composition according to any one of the items <1> to <10>, wherein the polyester resin has an ester group concentration of 1.0 mmol/g or more and ≤3.0 mmol/g.

<12> The asphalt composition according to any one of the items <1> to <11>, wherein the carboxylic acid component contains succinic acid substituted by an alkenyl group having ≥2 and ≤20 carbon atoms.

<13> The asphalt composition according to any one of the items <1> to <11>, wherein the carboxylic acid component contains succinic acid substituted by an alkenyl group having ≥2 and ≤20 carbon atoms in a content of ≥50% by mol and 100% by mol or less.

<14> The asphalt composition according to any one of the items <1> to <13>, wherein the asphalt composition has a content of the polyester resin of ≥2 parts by mass and ≤5 parts by mass per 100 parts by mass of the asphalt.

### EXAMPLES

### Measurement Methods

### (1) Measurement Method of Ester Group Concentration of Polyester Resin

The ester group concentration of the polyester resin was calculated according to the following formula.

Ester group concentration (mmol/g)=A/B

In the formula, A represents the molar number (mmol) of ester groups of the polyester resin, and B represents the mass (g) of the resin, which each were calculated according to the following formulas.

A (mmol)=2×(charged molar number (mmol) of component with smaller molar number between monomer components of alcohol component and carboxylic acid component)×(reaction rate)

B (g)=(total charged mass (g) of alcohol component and carboxylic acid component)−(mass (g) of water generated in synthesis of resin)

The reaction rate and the mass of water generated in synthesis of the polyester resin were calculated according to the following expressions.

(i) Reaction Rate in Case of Alcohol Component being Excessive to Carboxylic Acid Component

Reaction rate=1−((acid value (mgKOH/g) of polyester resin)/(acid value (mgKOH/g) in charging monomers)

The acid value in charging the monomers was assumed to be 2×(total charged molar number (mmol) of carboxylic acid component)×56.1/(total charged mass (g) of alcohol component and carboxylic acid component).

(ii) Reaction Rate in Case of Carboxylic Acid Component being Excessive to Alcohol Component

Reaction rate=(hydroxy value (mgKOH/g) of polyester resin)/(hydroxy value (mgKOH/g) in charging monomers)

The hydroxy value in charging the monomers was assumed to be 2×(total charged molar number (mmol) of alcohol component)×56.1/(total charged mass (g) of alcohol component and carboxylic acid component).

(iii) Mass of Water generated in Synthesis of Polyester Resin

Mass (g) of water generated in synthesis of polyester resin=2×18 (molecular weight of water)×A

### (2) Measurement Method of Acid Value and Hydroxy Value of Polyester Resin

The acid value and the hydroxy value of the polyester resin were measured according to the method of JIS K0070:1992, provided that only the measurement solvent was changed from the mixed solvent of ethanol and ether prescribed in JIS K0070:1992 to a mixed solvent of acetone and toluene (acetone/toluene=1/1 (volume ratio)).

### (3) Measurement Method of Glass Transition Temperature

A differential scanning calorimeter “Q-100” (available from TA Instruments Japan, Inc.) was used. A specimen weighed 0.01 to 0.02 g on an aluminum pan was heated to 200° C., and then cooled down to −80° C. at a cooling rate of 10° C./min. The specimen was then measured while heating to 150° C. at a heating rate of 10° C./min. The intersection point of the extended line of the base line below the maximum endothermic peak and the tangent line showing the maximum gradient from the rising point of the peak to the top of the peak was designated as the glass transition temperature.

### (4) Measurement Method of Melt Viscosity at 90° C. of Polyester Resin

The melt viscosity at 90° C. of the polyester resin was measured as following.

15 g of the heated polyester resin was injected to a sample tube dedicated for the following measurement equipment. The spindle and the heating device shown below were mounted on the measurement equipment. The temperature of the heating device was set to 90° C., and the specimen was heated for 2 hours. Thereafter, the viscosity of the polyester resin was measured.
Measurement equipment: Brookfield Model DV-II+ Viscometer (available from Brookfield Engineering Laboratories, Inc.)
Spindle: SC4-31
Heating device: Thermosel System (available from Brookfield Engineering Laboratories, Inc.)
Rotation speed: 20 rpm
Temperature: 90° C.

### (5) Measurement Method of Number Average Molecular Weight and Weight Average Molecular Weight of Polyester Resin

The molecular weight distribution was measured by the gel permeation chromatography (GPC) method in the following manner, from which the number average molecular weight (Mn) and the weight average molecular weight (Mw) were obtained.

### (i) Preparation of Specimen Solution

A specimen was dissolved in tetrahydrofuran at 60° C. to make a concentration of 0.5 g/100 mL. Subsequently, the solution was filtered with a PTFE type membrane filter having a pore diameter of 0.2 μm (“DISMIC-25JP”, available from Toyo Roshi Kaisha, Ltd.) to remove insoluble matters, so as to provide a specimen solution.

### (ii) Measurement of Molecular Weight

With the measurement equipment and the analysis columns described below, tetrahydrofuran as an eluent was allowed to flow at a flow rate of 1 mL/min to stabilize the columns in a thermostat chamber at 40° C. 100 μL of the specimen solution obtained in the item (i) was injected thereto to perform the measurement. The molecular weights of the specimen were calculated based on the calibration curve provided in advance.
Measurement equipment: HLC-8320GPC (available from Tosoh Corporation)
Analysis columns: GMHXL+G3000HXL (available from Tosoh Corporation)

The calibration curve was prepared with several kinds of monodisperse polystyrene “A-500” (5.0×10²), “A-1000” (1.01×10³), “A-2500” (2.63×10³), “A-5000” (5.97×10³), “F-1” (1.02×10³), “F-2” (1.81×10⁴), “F-4” (3.97×10⁴), “F-10” (9.64×10⁴), “F-20” (1.90×10⁵), “F-40” (4.27×10⁵), “F-80” (7.06×10⁵), “F-128” (1.09×10⁶) (all available from Tosoh Corporation) as the standard specimen. The numerals in parentheses show the molecular weights.

### Synthesis Example 1

### Production of Polyester Resin E-1

The alcohol component, the carboxylic acid component, and the esterification catalyst shown in Table 1 placed in a four-neck flask having a capacity of 10 L equipped with a nitrogen tube, a dehydration tube, an agitator, and a thermocouple, were retained at 180° C. for 1 hour under a nitrogen atmosphere, and then the temperature was increased to 220° C. over 4 hours at a heating rate of 10° C. per hour. After reaching 220° C., the temperature and a pressure of 8.0 kPa were retained until the target acid value was obtained, so as to provide a polyester resin E-1.

### Synthesis Examples 2, 3, 5, and 6

### Production of Polyester Resins E-2, E-3, E-5, and C-1

The polyester resins E-2, E-3, E-5, and C-1 were produced in the same manner as in Production Example 1 except that the alcohol components and the carboxylic acid components shown in Table 1 were used.

### Synthesis Example 4

### Production of Polyester Resin E-4

The alcohol component, the carboxylic acid component, and the esterification catalyst shown in Table 1 placed in a four-neck flask having a capacity of 10 L equipped with a nitrogen tube, a dehydration tube, an agitator, and a thermocouple, were retained at 180° C. for 1 hour under a nitrogen atmosphere, and then the temperature was increased to 210° C. over 3 hours at a heating rate of 10° C. per hour. After reaching 210° C., the temperature and a pressure of 8.0 kPa were retained until the target acid value was obtained, so as to provide a polyester resin E-4.

### Synthesis Example 7

### Production of Polyester Resin C-2

The alcohol component, the carboxylic acid component, and the esterification catalyst shown in Table 1 and 2 g of gallic acid (esterification promotor) placed in a four-neck flask having a capacity of 10 L equipped with a nitrogen tube, a dehydration tube, an agitator, and a thermocouple, were heated to 235° C. under a nitrogen atmosphere, retained at 235° C. under ordinary pressure for 5 hours, and then retained at 8.0 kPa and 235° C. for 1 hour. Thereafter, the temperature was decreased to 180° C., and adipic acid was placed therein, followed by heating to 210° C. over 3.5 hours. After reaching 210° C., the reaction mixture was retained for 1 hour, and then a temperature of 210° C. and a pressure of 16 kPa were retained until the target acid value was obtained, so as to provide a polyester resin C-2.

TABLE 1

| | | | Synthesis Example | | | | | | |
|---|---|---|---|---|---|---|---|---|---|
| | | | 1 | | 2 | | 3 | | 4 |
| Kind of Polyester resin | | | E-1 | | E-2 | | E-3 | | E-4 |
| Raw | Monomer composition | | Molar | Charged | Molar | Charged | Molar | Charged | Molar |
| material | | | ratio | amount | ratio | amount | ratio | amount | ratio |
| monomer | | | *8 | (g) | *8 | (g) | *8 | (g) | *8 |
| | Alcohol | BPA-2PO | | | | | | | |
| | component | adduct *1 | | | | | | | |
| | | BPA-4PO | | | | | 100 | 2527 | |
| | | adduct *2 | | | | | | | |
| | | BPA-6PO | | | 100 | 2662 | | | |
| | | adduct *3 | | | | | | | |
| | | BPA-16PO | 100 | 3234 | | | | | 100 |
| | | adduct *4 | | | | | | | |
| | | BPA-2EO | | | | | | | |
| | | adduct *5 | | | | | | | |
| | Carboxylic | Alkenylsuccinic | 95 | 766 | 95 | 1338 | 95 | 1474 | |
| | acid | acid *6 | | | | | | | |
| | component | Sebacic acid | | | | | | | 95 |
| | | Adipic acid | | | | | | | |
| | | Terephthalic | | | | | | | |
| | | acid | | | | | | | |
| Esterification | Tin(II) di(2- | | 20 | | 20 | | 20 | | 20 |
| catalyst | ethylhexanoate) *7 | | | | | | | | |
| | (charged amount (g)) | | | | | | | | |
| Properties | Ester group concentration | | 1.3 | | 2.5 | | 2.8 | | 1.4 |
| | (mmol/g) | | | | | | | | |
| | Acid value (mgKOH/g) | | 13 | | 11 | | 5 | | 10 |
| | Hydroxy value (mgKOH/g) | | 25 | | 23 | | 15 | | 20 |
| | Glass transition point/Tg | | −41.5 | | −8.0 | | 2.1 | | −49.9 |
| | (° C.) | | | | | | | | |
| | Melt viscosity at 90° C. | | 454 | | 9980 | | 21500 | | 1057 |
| | (mPa · s) | | | | | | | | |
| | Number average molecular | | 3900 | | 4000 | | 4330 | | 4920 |
| | weight Mn | | | | | | | | |
| | Weight average molecular | | 10500 | | 12300 | | 15800 | | 11900 |
| | weight Mw | | | | | | | | |
| | | | Synthesis Example | | | | | | |
| | | | 4 | 5 | | 6 | | 7 | |
| Kind of Polyester resin | | | E-4 | E-5 | | C-1 | | C-2 | |
| Raw | Monomer composition | | Charged | Molar | Charged | Molar | Charged | Molar | Charged |
| material | | | amount | ratio | amount | ratio | amount | ratio | amount |
| monomer | | | (g) | *8 | (g) | *8 | (g) | *8 | (g) |
| | Alcohol | BPA-2PO | | | | 100 | 2360 | 25 | 710 |
| | component | adduct *1 | | | | | | | |
| | | BPA-4PO | | | | | | | |
| | | adduct *2 | | | | | | | |
| | | BPA-6PO | | | | | | | |
| | | adduct *3 | | | | | | | |
| | | BPA-16PO | 3370 | 100 | 3524 | | | | |
| | | adduct *4 | | | | | | | |
| | | BPA-2EO | | | | | | 75 | 1977 |
| | | adduct *5 | | | | | | | |
| | Carboxylic | Alkenylsuccinic | | | | 95 | 1640 | | |
| | acid | acid *6 | | | | | | | |
| | component | Sebacic acid | 630 | | | | | | |
| | | Adipic acid | | 95 | 476 | | | 20 | 237 |
| | | Terephthalic | | | | | | 80 | 1077 |
| | | acid | | | | | | | |

| | | | | | |
|---|---|---|---|---|---|
| Esterification | Tin(II) di(2- | 20 | 20 | 20 | 20 |
| catalyst | ethylhexanoate) *7 | | | | |
| | (charged amount (g)) | | | | |
| Properties | Ester group concentration | 1.4 | 1.6 | 3.3 | 3.2 |
| | (mmol/g) | | | | |
| | Acid value (mgKOH/g) | 10 | 5 | 5 | 13 |
| | Hydroxy value (mgKOH/g) | 20 | 15 | 15 | 14 |
| | Glass transition point/Tg | −49.9 | −48.0 | 15.8 | 56.1 |
| | (° C.) | | | | |
| | Melt viscosity at 90° C. | 1057 | 770 | N.D. *9 | N.D. *9 |
| | (mPa · s) | | | | |
| | Number average molecular | 4920 | 4920 | 3700 | 3600 |
| | weight Mn | | | | |
| | Weight average molecular | 11900 | 12500 | 12200 | 12000 |
| | weight Mw | | | | |

The blended components and the notes in the table are as follows.
*1: Propylene oxide adduct of bisphenol A, average addition molar number: 2.2, molecular weight: 350
*2: Propylene oxide adduct of bisphenol A, average addition molar number: 3.9, molecular weight: 417
*3: Propylene oxide adduct of bisphenol A, average addition molar number: 5.8, molecular weight: 484
*4: Propylene oxide adduct of bisphenol A, average addition molar number: 16.3, molecular weight: 1,027
*5: Ethylene oxide adduct of bisphenol A, average addition molar number: 2.2, molecular weight: 325
*6: Dodecenylsuccinic anhydride (average molecular weight: 256)
*7: Tegokat 129 (available from TIB Chemicals AG)
*8: Molar amount per 100 mol of alcohol component (molar ratio)
*9: Unmeasurable due to large exceedance of measurement limit

### Application Example 1

600 g of straight asphalt (Performance Grade (PG) 64-22, available from Associated Asphalt, Inc.), was heated to 165° C. and weighed in a 500 mL canister, to which 30 g of the polyester resin E-1 obtained in Synthesis Example 1 (5 parts by mass per 100 parts by mass of asphalt) was added. After closing the cap of the canister for preventing the oxidation of asphalt, the components were agitated at 165° C. and agitation rate of 200 rpm for 1 hour, to prepare the asphalt composition AS-1.

Subsequently, the resulting asphalt composition AS-1 was used, according to AASHTO R30-02. The aggregates shown below, and the asphalt composition were mixed at 165° C. Thereafter, the mixture was retained at 160° C. for 2 hours in a ventilation oven, to prepare an asphalt mixture (hot-mix asphalt). Specifically, by using the aggregate blend shown below, the asphalt composition AS-1 was blended to target an asphalt (straight asphalt) content of 5.9% in the hot-mix asphalt, to provide an asphalt mixture M-1.

### Aggregate

The aggregate used was an aggregate available from Blythe Construction, Inc. 2,600 g of the aggregate contained 650 g of ballast (coarse aggregate), 1,690 g of screenings (fine aggregate), and 260 g of pit sand (fine aggregate). The passing mass percentages of the components were as follows.

### Passing Mass Percentage:

### Ballast

Sieve mesh 9.50 mm: 90.4% by mass
Sieve mesh 8.00 mm: 73.3% by mass
Sieve mesh 4.75 mm: 24.8% by mass
Sieve mesh 2.80 mm: 3.9% by mass
Sieve mesh 1.00 mm: 1.2% by mass
Sieve mesh 0.50 mm: 0.8% by mass

### Screenings

Sieve mesh 9.50 mm: 100.0% by mass
Sieve mesh 8.00 mm: 99.9% by mass
Sieve mesh 4.75 mm: 98.2% by mass
Sieve mesh 2.80 mm: 77.4% by mass
Sieve mesh 1.00 mm: 36.8% by mass
Sieve mesh 0.50 mm: 22.1% by mass

### Pit Sand

Sieve mesh 9.50 mm: 100.0% by mass
Sieve mesh 8.00 mm: 100.0% by mass
Sieve mesh 4.75 mm: 98.0% by mass
Sieve mesh 2.80 mm: 94.2% by mass
Sieve mesh 1.00 mm: 70.6% by mass
Sieve mesh 0.50 mm: 33.6% by mass

### Evaluation

### Measurement of Marshall Stability

The Marshall stability of the asphalt mixture was measured according to ASTM D6927-15 with the measurement equipment shown below. The results are shown in Table 2.

A higher Marshall stability (kN) measured means a better stability strength of the pavement.
Measurement equipment: 850 Digital Test Press (available from Pine Instrument Co.)

### Evaluation of Cracking Resistance: IDEAL-CT

The cracking resistance of the asphalt mixture was evaluated by means of IDEAL-CT (CT-INDEX) thereof according to ASTM D8225-19 using the measurement equipment shown below. The results are shown in Table 2.

A higher IDEAL-CT index means a better cracking resistance of the pavement.
Measurement equipment: 850 Digital Test Press (available from Pine Instrument Co.)
Addition device (attachment): Smart-Jig-Digital Data Collection (available from InstroTek, Inc.)

### Application Examples 2 and 3

Asphalt mixtures were obtained in the same manner as in Application Example 1 except that the blending amount of the polyester resin E-1 was adjusted to 12 g (2 parts by mass per 100 parts by mass of asphalt) and 60 g (10 parts by mass per 100 parts by mass of asphalt), respectively. The Marshall stability and the IDEAL-CT (CT-INDEX) were measured in the same manner as in Application Example 1. The results are shown in Table 2.

### Comparative Application Examples 4 to 7 vs Application Examples 2 and 3

Asphalt mixtures were obtained in the same manner as in Application Example 1 except that the polyester resin E-1 was replaced with the polyester resins E-2 to E-5, C-1, and C-2 obtained in Synthesis Examples 2 to 7, respectively. The Marshall stability and the IDEAL-CT (CT-INDEX) were measured in the same manner as in Application Example 1. The results are shown in Table 2.

### Application Example 8

An asphalt mixture was obtained in the same manner as in Example 1 except that the 30 g of polyester resin E-1 in Example 1 was replaced with a combination of 30 g of polyester resin E-1 and 30 g of polyester resin C-2 (5 parts by mass each per 100 parts by mass of asphalt). The Marshall stability and the IDEAL-CT (CT-INDEX) were measured in the same manner as in Application Example 1. The results are shown in Table 2.

### Comparative Application Example 1

An asphalt mixture was obtained in the same manner as in Application Example 1 except that the polyester resin E-1 in Application Example 1 was incorporated. The Marshall stability and the IDEAL-CT (CT-INDEX) were measured in the same manner as in Application Example 1. The results are shown in Table 2.

TABLE 2

| | | | Polyester resin | | Evaluation | |
|---|---|---|---|---|---|---|
| | | | | Content | Marshall | IDEAL- |
| Application | Asphalt | Asphalt | | (part by | stability | CT (CT- |
| Examples | composition | Kind | Kind | mass) *1 | (kN) | INDEX) |
| Example 1 | AS-1 | straight | E-1 | 5 | 17.1 | 42.4 |
| | | asphalt | | | | |
| Example 2 | AS-2 | straight | E-1 | 2 | 18.4 | 30.1 |
| | | asphalt | | | | |
| Example 3 | AS-3 | straight | E-1 | 10 | 15.3 | 44.2 |
| | | asphalt | | | | |
| Example 4 | AS-4 | straight | E-2 | 5 | 18.2 | 30.2 |
| | | asphalt | | | | |
| Example 5 | AS-5 | straight | E-3 | 5 | 19.7 | 28.3 |
| | | asphalt | | | | |
| Example 6 | AS-6 | straight | E-4 | 5 | 17.2 | 35.5 |
| | | asphalt | | | | |
| Example 7 | AS-7 | straight | E-5 | 5 | 17.2 | 34.9 |
| | | asphalt | | | | |
| Example 8 | AS-8 | straight | E-1 + | 5 + 5 | 20.8 | 34.8 |
| | | asphalt | C-2 | | | |
| Comparative | AS-C0 | straight | — | 0 | 18.2 | 25.2 |
| Example 1 | | asphalt | | | | |
| Comparative | AS-C1 | straight | C-1 | 5 | 19.1 | 25.1 |
| Example 2 | | asphalt | | | | |
| Comparative | AS-C2 | straight | C-2 | 5 | 19.3 | 26.6 |
| Example 3 | | asphalt | | | | |

The note in the table is as follows.
*1: Content per 100 parts by mass of asphalt (part by mass)

Data in Table 2 shows that the presence of polyester resins in the asphalt compositions of Application Examples 1 to 8 provide improved cracking resistance properties while maintaining a good Marshall stability, as compared to the asphalt compositions of Comparative Examples.

Asphalt pavement generally varies in Marshall stability and crack resistance (i.e., the value of IDEAL-CT) depending on the content of asphalt. In the case where a polymer compound is used as an asphalt modifier, the favorable asphalt content might vary. However, in the case where the particular polyester resin according to the present invention is used as an asphalt modifier, the target asphalt content does not vary, and consequently good Marshall stability can be maintained for all Examples.

1: An asphalt composition comprising asphalt and a polyester resin, wherein
the polyester resin comprises a constitutional unit derived from an alcohol component and a constitutional unit derived from a carboxylic acid component, and the alcohol component comprises ≥30% by mol of an alkylene oxide adduct of bisphenol A,
the polyester resin having a glass transition temperature of ≥−70° C. and ≤10° C.,
the asphalt composition having a content of the polyester resin of ≥0.5 part by mass and ≤15 parts by mass per 100 parts by mass of the asphalt.

2: The asphalt composition according to claim 1, wherein the polyester resin has a melt viscosity at 90° C. of ≥300 mPa·s and ≤30,000 mPa·s.

3: The asphalt composition according to claim 1, wherein the polyester resin has an ester group concentration of ≥1.0 mmol/g and ≤3.0 mmol/g.

4: The asphalt composition according to claim 1, wherein the alkylene oxide adduct of bisphenol A has an average addition molar number of the alkylene oxide of ≥5 and ≤20.

5: The asphalt composition according to claim 1, wherein the carboxylic acid component comprises succinic acid substituted by an alkenyl group having ≥2 and ≤20 carbon atoms.

6: The asphalt composition according to claim 1, wherein the alkylene oxide adduct of bisphenol A is a propylene oxide adduct of bisphenol A.

7: The asphalt composition according to claim 1, wherein the carboxylic acid component is at least one selected from the group consisting of an aliphatic dicarboxylic acid, an aromatic dicarboxylic acid, and a tribasic to hexabasic polybasic carboxylic acid.

8: The asphalt composition according to claim 1, wherein the carboxylic acid component comprises an aliphatic dicarboxylic acid, and the aliphatic dicarboxylic acid has a main chain having from 4 to 10 carbon atoms.

9: The asphalt composition according to claim 1, wherein the polyester resin has an acid value of from 5 mgKOH/g to 40 mgKOH/g.

10: The asphalt composition according to claim 1, wherein the polyester resin has a number average molecular weight of from 2,500 to 10,000.

11: The asphalt composition according to claim 1, wherein the carboxylic acid component comprises succinic acid substituted by an alkenyl group having from 2 to 20 carbon atoms.

12: A method for producing the asphalt composition according to claim 1, comprising: mixing the asphalt and the polyester resin at a temperature of from 140° C. to 190° C.

13: An asphalt mixture comprising at least an aggregate and the asphalt composition according to claim 1.

14: The asphalt mixture according to claim 13, wherein a content of the aggregate in the asphalt mixture is from 85% by mass to 98% by mass based on 100% by mass of the asphalt mixture.

15: A method for producing the asphalt mixture according to claim 13, comprising: mixing the aggregate and the asphalt composition at a temperature of from 130° C. to 230° C.

16: A road pavement method comprising: mixing the asphalt composition according to claim 1 and a heated aggregate to obtain an asphalt mixture; and laying down the obtained asphalt mixture on a road to form an asphalt pavement layer.
